(19) United States
(12) Patent Application Publication
(10) Pub. No.: US 2009/0002779 A1
(43) Pub. Date: Jan. 1, 2009

(54) Printing support system and printing support method

(75) Inventor: Yoshiki Fukui, Nagano (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/082,564

(22) Filed: Apr. 10, 2008

(30) Foreign Application Priority Data
Apr. 11, 2007 (JP) 2007-103669

(51) Int. Cl. H04N 1/04

(52) U.S. Cl. 358/488

(57) ABSTRACT

Disclosed is a printing support system that includes an acquisition unit which acquires image data by scanning a medium having a fold position as a recognizer at a position which corresponds to a fold position on a print out form, a recognition unit which recognizes the recognizer from the image data, an identification unit which identifies a position on the medium, the position corresponding to the fold position on the print out form on the basis of the recognized recognizer, and a generation unit which generates printing control information which specifies the print out form on the basis of the recognized position.

### BACKGROUND

1. Technical Field

The present invention relates to a printing support system, a printing support method, and a printing support program which can allow a user to set a print form in a simple manner.

2. Related Art

There is a known printing control method in which information about printing job is considered as printing job definition data (DPA, JDF, etc.) when printing print data described in Page Description Language (PDL) such as PostScript. The printing job definition data is setting information relating to a print form of printed matter, but a parameter setting method has a problem in that it is difficult to set the print form as intended when the setting information is not sufficiently detail.

As a method of making printing setting easier, there were known a technique (JP-A-2006-178747) in which printing setting which is preliminarily stored and associated with the common pattern expressed in contents data is used, and a technique (JP-A-2003-162406) in which a page size of contents data and a paper size that is available in a printing device are compared, and the printable setting is automatically performed.

However, the above-mentioned techniques need preliminarily prepared templates, and thus the techniques have a problem in that a printing director cannot easily determine a print out form.

### SUMMARY

An advantage of some aspects of the invention is that it provides a printing support system which is capable of easily determining contents of a print form without performing complicated user interface (UI) operation by a printing director and without the presence of setting information when generating printing job definition data.

According to one aspect of the invention, there is provided a printing support system which supports performing a printing process by specifying a print form and includes a directions input acquisition unit which acquires input contents inputted onto a paper-like medium served as a directions input means of the print form, a print form analysis unit which analyzes the print form on the basis of the acquisition result obtained by the directions input acquisition unit, and a printing control information generation unit which generates printing control information in order to perform a printing process according to the analysis result made by the print form analysis unit.

With such a structure, it is possible to easily acquire the directions input contents of the print form inputted onto the paper-like medium served as the directions input means by the directions input acquisition unit, can analyze the print form on the basis of the acquisition result by the print form analysis unit, and generate the printing control information which realizes the print form directed by the printing control information generation unit. Accordingly, it is possible to easily perform print setting by an intuitive method using the print form and the paper-like medium without the use of complicated UI operation and without the presence of setting information such as printing job definition data.

The paper-like medium means a medium having the same morphologic feature as a printing medium such as paper. Paper or film may be the paper-like medium.

The print form is a format of a printed material and does not exclusively mean a print out form which is a final format of a printed material, which is the result of a series of printing processing (pre-press, press, and post-press). That is, the print form includes print forms of a printed material being in the middle of printing processing. Accordingly, it is possible to apply this embodiment to the case of setting up the print form after the press processing and before the post press processing.

In the printing support system, it is preferable that the directions input acquisition unit includes an image analysis portion which recognizes a recognizer representing the print form from the image marked on the paper-like medium having the inputted directions about the print form, and the print form analysis unit analyzes the print form on the basis of the recognition result by the image analysis portion.

With such a structure, inputted contents are recognized on the basis of the image marked on the paper-like medium by the image analysis portion, the print form is analyzed by the print form analysis unit on the basis of the recognition result, and the print control information is generated on the basis of the analysis result. Here, recognizers include all kinds that can be acquired by an image, such as a character, a diagram, a symbol, and a sign remaining on the paper-like medium.

In the printing support system, it is preferable that the image analysis portion identifies arrangement status of the recognizers, which are recognized from the image, on the paper-like medium, and the print form analysis unit analyzes the print form on the basis of the identification result of the arrangement status of the recognizers by the image analysis portion.

With such a structure, the recognizers provided to the paper-like medium are recognized by the image analysis portion, the arrange status of the recognizers on the paper-like medium is identified, and the print form is analyzed on the basis of the arrangement status. Accordingly, printing control information used for realizing such print form is generated by the printing control information generation unit. That is, in the procedure in which the print form is reproduced on the paper-like medium while the paper-like medium is regarded as a printing medium, the marking (recognizer) is recognized by the image analysis portion and thus the printing control information which causes the print form to be realized is automatically generated by marking a position which is intended to be printed with contents or a fold position on the paper-like medium. Accordingly, it is no necessary for a printing director to specify the position using a character or the like, but it is possible for the printing director to intuitively input directions just by writing a line diagram at the position to be printed and thus easily set the print form.

It is preferable that the paper-like medium according to this aspect can express information by the means of handwriting on the surface of paper.

In the printing support system, it is preferable that the fold position specifying recognizer is provided at a position on the paper-like medium, the position corresponding to a fold position on the print form, as the recognizer, and the image analysis portion recognizes the fold position specifying recognizer and includes a fold directions recognition portion which recognizes a position on the paper-like medium, the position corresponding to the fold position on the print form.

With such a structure, the fold position specifying recognizer is recognized and the positional relationship on the paper-like medium is identified by the fold directions recognition portion, a fold on the print form is analyzed by the print form analysis unit on the basis of the identification result, and the printing control information is generated by the printing control information generation unit according to the analysis result. Accordingly, the printing director determines the fold position by reproducing a fold on the paper-like medium as the print form and can intuitively input directions by just writing in the fold position specifying recognizers with a line diagram, and thus it is possible to easily set the print form.

In the printing support system, it is preferable that the fold position specifying recognizer is a crease provided to the surface of paper by folding the paper-like medium, and the fold directions recognition unit recognizes the crease from the image as the fold position specifying recognizer.

With such a structure, the crease is recognized by the fold directions information acquisition unit, the fold position is acquired on the basis of the positional relationship, the fold directions information is acquired on the basis of the fold position, and the printing control information is generated by the printing control information generation unit. Accordingly, the printing director can specify the fold position by just reproducing the fold on the paper-like medium as the print form instead of intentionally writing in the fold position specifying recognizer at the fold position, and thus it is more simply set the fold.

In the printing support system, it is preferable that the a staple position specifying recognizer is provided at a position on the paper-like medium, the position corresponding to a staple position on the print form, as the recognizer, and the image analysis unit recognizes the stale position specifying recognizer and includes a staple directions recognition portion which recognizes a position on the paper-like medium provided with the recognized staple position specifying recognizer, the position corresponding to a staple position on the print form.

With such a structure, the staple position specifying recognizer is recognized by the staple directions recognition portion, the positional relationship on the paper-like medium is identified, the staple position on the print form is analyzed on the basis of the recognition and identification results by the print form analysis unit, and the printing control information is generated by the printing control information generation unit according to the analysis result. Accordingly, the printing director can intuitively input directions by determining the staple position just by reproducing the final form on the paper-like medium and writing in the staple position specifying recognizer with a line diagram according to staple position determination. Thus, it is possible to easily set the print form.

In the printing support system, it is preferable that a print position specifying recognizer is provided at a position or in a range on the paper-like medium, the position or the range corresponding to a print position or a print range of contents on the print form, as the recognizer, and the image analysis unit recognizes the print position specifying recognizer and includes a print position directions recognition portion which identifies a position on the paper-like medium having the recognized print position specifying recognizer, the position corresponding to the print position or the print range of the contents on the print form.

With such a structure, the print position specifying recognizer is recognized by the print position recognition unit, the positional relationship on the paper-like medium is identified, the print position or the print range on the print form is analyzed on the basis of the recognition and identification results, and the printing control information is generated by the printing control information generation unit according to the analysis result. Accordingly, the printing director can intuitively input directions by determining the print position or the print range just by reproducing the final for on the paper-like medium and input the print position specifying recognizer with a line diagram. Thus it is possible to easily set the print form.

In the printing support system, it is preferable that the image analysis unit includes a character directions recognition portion which recognizes characters on the paper-like medium.

With such a structure, the characters are recognized by the character directions recognition portion, the print form expressed by the characters is analyzed by the print form analysis unit, and the printing control information is generated by the printing control information generation unit according to the analysis result. That is, it is possible to allow the printing director to easily set the print form by writing the characters on the surface of the paper-like medium.

In the printing support system, it is preferable that the printing control information generation unit includes a printing job definition data generation portion which generates printing job definition data which corresponds to the analysis result made by the print form analysis unit.

With such a structure, the printing job definition data such as JDF and DPA used for realizing the print form which is analyzed by the print form analysis unit is generated by the printing control information generation unit, and it is possible to realize the print form specified by the printing using the generated data.

Furthermore, the printing control information generated by the printing control information generation unit is not limited to the printing job definition data.

According to another aspect of the invention, there is provided a printing support program which support performing a printing by specifying a print form and which causes a computer to execute a processing including a directions input acquiring step of acquiring input contents inputted on a paper-like medium for receiving directions input of the print form, a print form analysis step of analyzing the print form on the basis of the acquisition result at the directions input acquisition step, and a printing control information generation step of generating printing control information for performing a printing according to the analysis result at the print form analysis step.

With such a configuration, the program is read out by a computer, and the computer executes the read program. As a result, the same operation and advantages of the printing support system can be achieved.

### BRIEF DESCRIPTION OF THE DRAWINGS

The invention will be described with reference to the accompanying drawings, wherein like numbers reference like elements.

FIG. 1 is a functional block diagram illustrating functions of a printing support system according to one embodiment of the invention.

FIG. 2 is a view illustrating a paper-like medium served as directions input means.

FIG. 3 is a view illustrating an example of a printing job definition data.

FIG. 4 is a view illustrating a hardware composition of a host terminal.

FIG. 5 is a flowchart illustrating operation flow of the printing support system.

FIG. 6 is a view illustrating the status of determining a print out form.

FIG. 7 is a view illustrating an example of directions input using a paper-like medium.

FIG. 8 is a view illustrating another example of directions input using a paper-like medium.

FIG. 9 is a view illustrating a further example of directions input using a paper-like medium.

FIG. 10 is a view illustrating an example of an application, which is wrapping paper.

### DESCRIPTION OF EXEMPLARY EMBODIMENTS

Hereinafter, embodiments of the invention will be described with reference to the accompanying drawings.

### Structure of Printing Support System

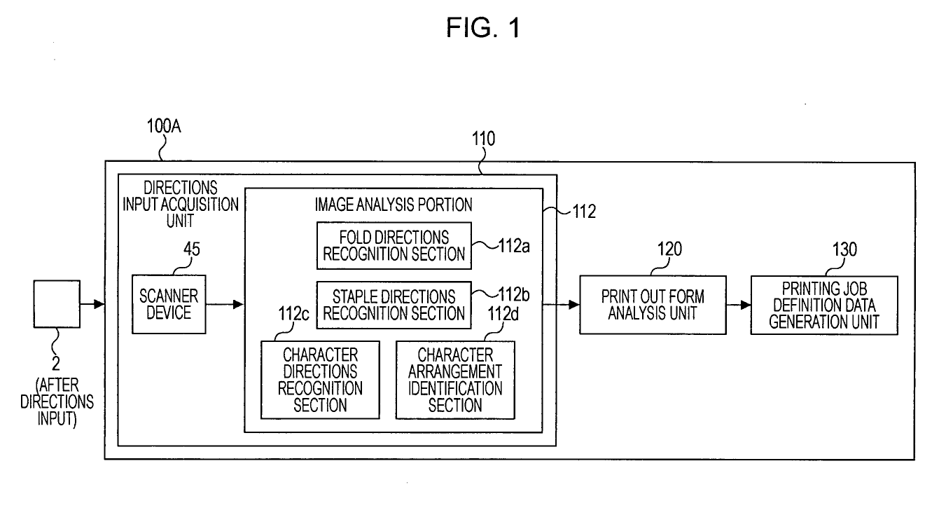

FIG. 1 shows a functional block diagram of a printing support system 100A according to one embodiment of the invention.

The printing support system 100A includes a directions input acquisition unit 110 which is constituted by a host terminal 100 and acquires input contents inputted into a paper-like medium 2 served as a directions input means.

The directions input acquisition unit 110 includes a scanner device 45 which reads the paper-like medium 2 into which directions are inputted and acquires image data, and an image analysis portion 112 which recognizes a recognizer representing a print out form by analyzing the image data on the paper-like medium 2, which is acquired by the scanner device 45. The image analysis portion 112 is equipped with a fold directions recognition section 112a, a staple directions recognition section 112b, a character directions recognition section 112c, and a character arrangement identification section 112d. Among these, the fold directions recognition section 112a recognizes a fold position specifying recognizer given to the paper-like medium 2, and identifies the position on the paper-like medium 2 to which the fold position specifying recognizer is given. Moreover, the staple directions recognition section 112b recognizes a staple position specifying recognizer given to the paper-like medium 2, and identifies the position on the paper-like medium 2 to which the staple position specifying recognizer is given. Moreover, the character directions recognition section 112c recognizes characters given to the paper-like medium 2, and the character arrangement identification section 112d identifies the character arrangement on the paper-like medium 2 (the direction of characters, character position, etc.).

Furthermore, the host terminal 100 is equipped with the print out form analysis unit 120 which analyzes the print out form on the basis of the acquisition result of the directions input acquisition unit 110 and a printing job definition data generation unit 130 which generates printing job definition data on the basis of the analysis result of the print out form analysis unit 120.

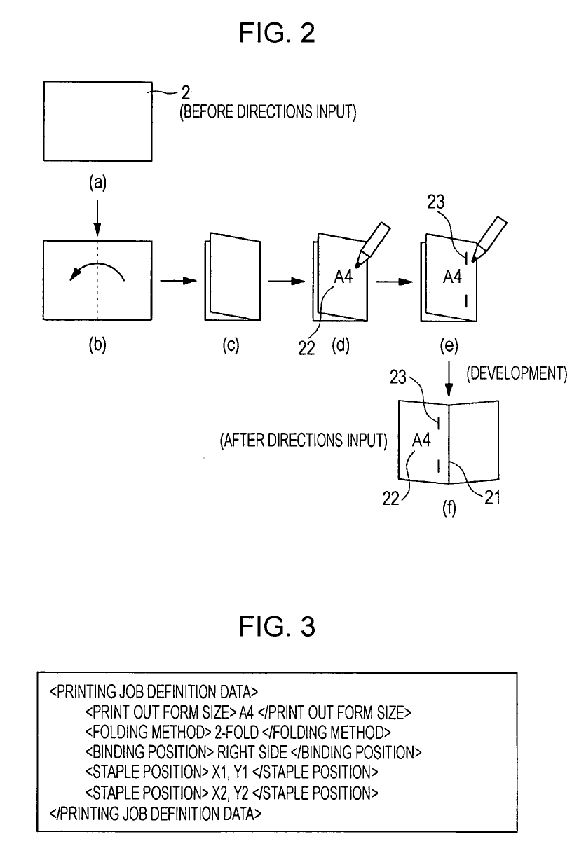

FIG. 2 shows the paper-like medium 2 serving as directions input means.

The paper-like medium 2 has the common morphological feature of printing media used for printing and can display information on the surface thereof by the means of handwriting, etc. For example, the paper-like medium 2 may be paper as shown in FIG. 2. A printing director inputs directions of the print out form by expressing a recognizer, such as a diagram, a sign, and a character on paper-like medium 2. It is not necessary that the size of the paper-like medium 2 is the really same size as the target print out form. When the size of the paper-like medium 2 is different from the real size of the print out form, as it will be described later, the size conversion of the printing result will be carried out to fit the size of the paper-like medium 2 by specifying the size of the print out form.

In order to determine the print out form, the directions including the print out size, the result number of print out pages, the method of filing, the staple method (the number of staples, a staple position, etc.), fold information (a fold position, the order of folds, a fold kind, etc.), a print position, and a print range (single-sided, double-sided) etc. can be inputted. In addition, the directions input of the print out form may be any of printing specification information and printing setting information. For example, you may describe the paper size (printing setup) used for printing instead of the result size (printing specification).

Moreover, as the recognizer, the characters which express the contents of the print out form directly, the signs and diagrams which corresponds to the print out form, the signs and diagrams (position specifying recognizer) which express directions information about the position of the print out form on the paper-like medium 2, etc. can be used. With this embodiment, a fold position specifying recognizer and a staple position specifying recognizer are used as a position specifying recognizer. In greater detail, it is possible to direct the fold position in a manner such that the fold position specifying recognizer expresses a position corresponding to the fold position on the print out form. Such a position can be easily specified in a manner such that the printing director reproduces the print out form by the paper-like medium 2. Moreover, the staple position specifying recognizer can be similarly used so as to express a position on the print out form, which corresponds to the staple position. In addition, with this embodiment, the character written to specify the contents of the print out form can be used as the position specifying recognizer, and the filing method may be determined in a manner described later.

Moreover, as the input method of the recognizer, there may be a method of directly entering signs and diagrams on the surface of paper and a method of leaving traces which can be recognized, such as making a crease on the paper-like medium 2. When inputting the fold position specifying recognizer, it is also possible to enter lines or signs that are determined as the fold position specifying means along the position which is specified. However, it is possible to carry out directions input of the fold position by creasing the fold position. If this method is used, the printing director can input the position specifying recognizer more easily.

In an example of FIG. 2, it is shown that the printing director inputs the directions information about the print out form on the paper-like medium 2. The printing director folds the paper-like medium 2 in about half in the longitudinal direction by reproducing the print out form (see (b) to (c) in FIG. 2), then writes the characters “A4” on the outer surface of the paper-like medium 2 (see (d) in FIG. 2), and finally marks staple position specifying recognizers on the same surface of the paper-like medium (see (e) in FIG. 2). In this manner, after all the directions are inputted (see (f) in FIG. 2), the developed surface of the paper-like medium 2 has a crease 21, the characters 22 which specify the size of print out form, and a pair of staple position specifying recognizers 23 and 23. In this manner, it is possible to acquire the contents of directions input made by the printing director.

The example of printing job definition data is shown in FIG. 3. As described above, printing job definition data is data used for printing processing. With this embodiment, the information on the print out from is included and, thus printing processing can realize the print out form. The printing job definition data of FIG. 3 prescribes the print out form by describing a tag set of a start tag and an end tag in the shape of a nest between a predetermined start tag (for example, <printing job definition data>) and a predetermined end tag (for example, </printing job definition data>). The printing job definition data can be described in recognizer markup languages, such as eXtensible Markup Language (XML). In addition, printing job definition data is a concept which includes the both of the printing job definition data which describes the specification of desired printed matter as the final product resulted from printing processing and printing job setting data which describes a setup in connection with the printing job definition data and a printer.

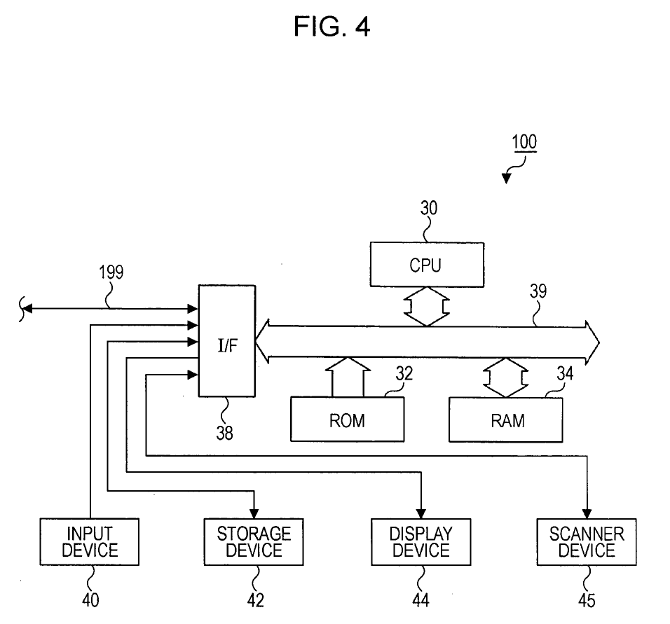

FIG. 4 shows the hardware composition of the host terminal 100. The host terminal 100 includes a control processing unit (CPU) 30 which controls operation and the whole system based on a control program, a read only memory (ROM) 32 which stores the control program of CPU 30 etc. in a predetermined domain, a random access memory (RAM) 34 for storing data read from the ROM 32 and operations result required in the operation process of the CPU 30, and an interface unit (I/F) 38 which carry input and output of data to an external device. These can be connected with each other via buses 39 which are signal wires for data transmission.

The I/F 38 is connected with an input device 40 such as a keyboard, a mouse, etc. which is an external device and a human interface and by which data can be inputted, a memory storage 42 which stores data, a table, etc. in a file format, a display 44 which displays a screen on the basis of a picture signal, the above-mentioned scanner device 45, and a signal line for connecting with a network 199.

### Operation of Printing Support System

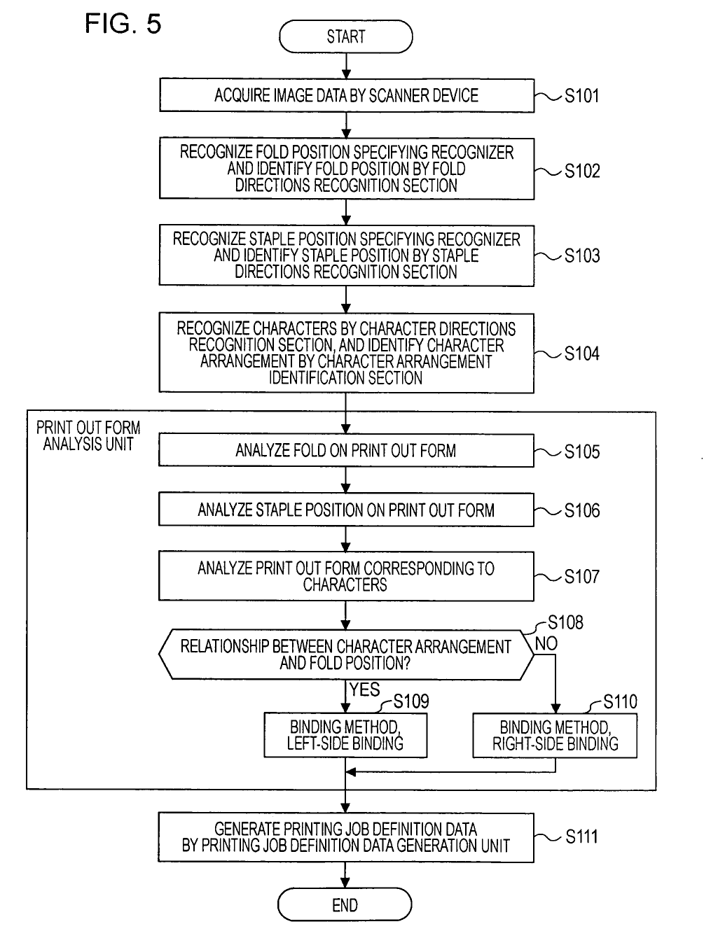

FIG. 5 sows the operation flow of the printing support system 10A. In addition, this operation is realized by performing a program containing a printing support program concerning this invention at the host terminal 100.

First, in step S101, image data is acquired by the scanner device 45 in a manner such that the scanner device 45 reads the paper-like medium 2 into which directions input is carried out. At this time, when the paper-like medium 2 is folded, the paper-like medium 2 is read out in the developed status.

Next, in step S102, a fold position specifying recognizer is recognized by the fold directions recognition section 112a, and the position on the paper-like medium 2 to which the fold position specifying recognizer is given is identified. Since the fold position specifying recognizer is inputted as a crease, a diagram, a sign, etc., the fold directions recognition section 112a compares information for identifying these which have been memorized with feature data extracted from image data, and, specifically, recognizes the fold position specifying recognizer. Moreover, the identification result of the position on the paper-like medium 2 is expressed as a relative coordinate over the entire portion of the paper-like medium 2.

In addition, when there is a plurality of fold position specifying recognizers, the same processing is performed with respect to each of the fold position specifying recognizers. Moreover, at this time, a mountain fold and a valley fold may be discriminated, and you may acquire information representing the order or the kinds of folds. When the classification of each fold, such as a mountain fold and a valley fold is required from the crease of the paper-like medium 2, the kinds of folds may be stored as information for discriminating the kinds of folds. When the order of the folds are needed to be identified from the fold position specifying recognizers which are inputted by the printing director, the kinds of the folds may be changed or signs which represent the kinds of the folds may be recorded together.

Next, in step S103, the staple directions recognition section 112b recognizes a staple position specifying recognizer and the position on the paper-like medium 2 is identified. In the similar manner as described above, when the staple position specifying recognizer is given to a plurality of places, the processing described above is carried out with respect to each of the staple position specifying recognizers. A staple position can be acquired as two-dimensional coordinates, and may be changed into a relative coordinate or into an absolute coordinate. Next, in Step S104, the character directions recognition section 112c acquires character data by recognizing characters from the image data.

Next, through steps S105 to S110, the print out form analysis unit 120 analyzes the directed print out form on the basis of the contents of the directions inputs over the paper-like medium 2, which are obtained through steps S102 to S104.

In greater detail, in step S105, the fold position on the print out form is analyzed on the basis of the position information on the paper-like medium 2 to which the fold position specifying recognizers, which are acquired it step S102, are given, and the final folding method is determined. When there is a plurality of fold position specifying recognizers, the folding method including the kinds and the order of folds is determined on the basis of the positional relationship of the recognizers. When information about the kinds of folds (a mountain fold and a valley fold) and the order of folds is acquired in step S102 at this time, the information may be used to determine the order of folds and the kinds of folds. For example, when two creases oriented in the longitudinal direction and arranged at equal intervals are detected, if both creases are valley folds, the paper-like medium will be rolled inward to become three-fold. On the other hand, if one crease is a mountain fold and the other is a valley fold, the paper-like medium is folded outward to become three-fold.

Then, in step S106, a staple method is analyzed on the basis of the position on the paper-like medium 2 to which the staple position specifying recognizer acquired in step S103 is given. In greater detail, when the position of the staple position specifying recognizer is acquired as a relative coordinate on the paper-like medium 2 in step S103, this is changed into the coordinates on the print out form. Then, in step S107, the print out form is analyzed on the basis of the character data acquired in step S104. Thus, information, such as the print out size is acquirable.

Through subsequent steps S108 to S110, a binding method on the print out form is determined on the basis of the relationship between the character arrangement information acquired in step S103 and the fold position information acquired in step S102. In greater detail, in step S108, the character position acquired in step S104 and the position recorded at the fold position specifying recognizer, which is acquired in step S102, are compared, and then the binding method is determined depending on the positional relationship. For example, first the up-and-down direction of the paper-like medium 2 is determined by the direction of the characters. Next, when the characters are on the left side of the fold, the binding method becomes the right-side binding (step S109). On the contrary, when the characters are on the right side of the fold, the binding method becomes the left-side binding (step S110).

After acquiring the analysis information on print out form as mentioned above in Step S111, the printing job definition data for realizing suitable print out form is generated by the printing job definition data generation unit 130 on the basis of the directions information and analysis information. Thereby, desired print out form is realized by performing a printing job using the printing job definition data.

In addition, in the above-mentioned embodiment, the paper-like medium 2 corresponds to the paper-like medium according to the aspects of the invention. The scanner device 45 and the image analysis portion 112 correspond to the directions input acquisition unit according to the aspect of the invention. The image analysis portion 112 corresponds to the image analysis portion according to the aspect of the invention, and the fold directions recognition section 112a corresponds to the fold directions recognition portion according to the aspect of the invention. The staple directions recognition section 112b corresponds to the staple directions recognition portion according to the aspect of the invention. The character directions recognition section 112c corresponds to the character directions recognition portion according to the aspect of the invention. The print out form analysis unit 120 corresponds to the print form analysis unit according to the aspect of the invention. The printing job definition data generation unit 130 corresponds to the printing job definition data generation unit according to the aspect of the invention.

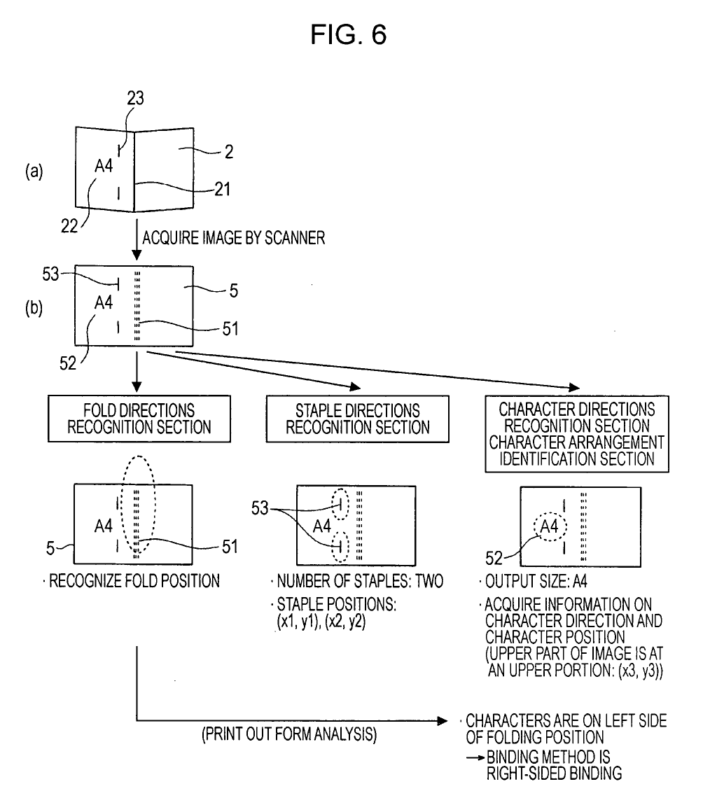

FIG. 6 shows a method of determining the print out form the paper-like medium 2 into which directions information is inputted as shown in FIG. 2.

In FIG. 6, the paper-like medium 2 into which the directions input is carried out is developed and it is introduced into the scanner device 45 in the state in which it turned in the direction in which the directions entry side is read (see part (a) of FIG. 6). Thus, the image data 5, which includes a crease (fold) 51, a character string 52, and a pair of staple position specifying recognizers 53 and 53, is acquired (see part (b) of FIG. 6). Then, the fold directions recognition section 112a acquires a fold position (the center in the longitudinal direction) by recognizing the crease 51, the staple directions recognition section 112b acquires the number of staples (=2) and staple coordinates ((x1, y1), (x2, y2)) by recognizing the staple position specifying recognizers 53 and 53, and the character directions recognition section 112c acquires the character data (=A4) of the size of the print out form by recognizing the character string 52. As the result of analyzing this, the printing job definition data shown in FIG. 3 is generated.

### Modification

In addition, application of this invention is not limited to the above-mentioned embodiment.

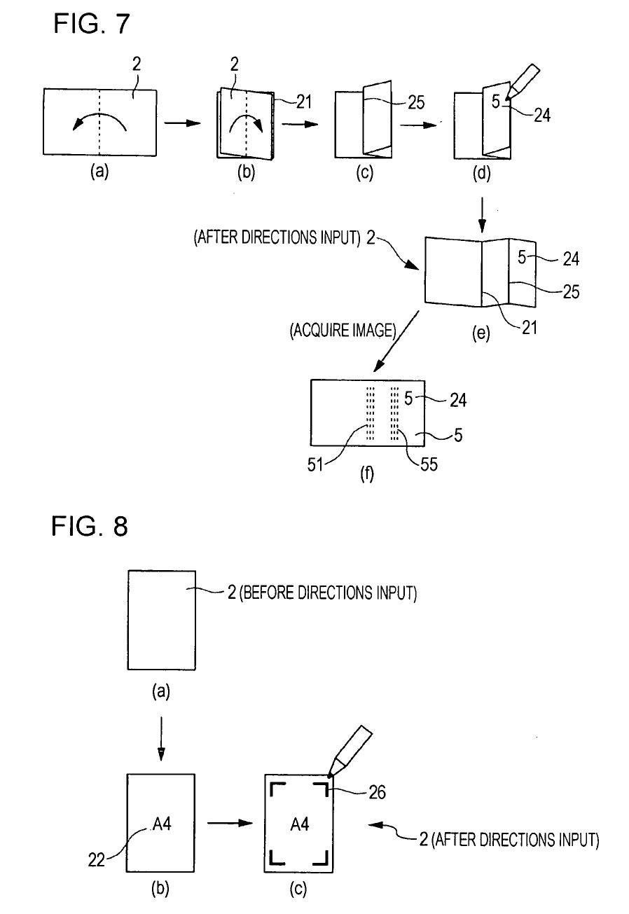

FIG. 7 shows an example of directions input using the paper-like medium 2.

FIG. 7 is the case in which a further directions input is carried out after acquiring the directions information by the printing support system 100A from the paper-like medium 2 into which the directions input is finished as shown in FIG. 2. The printing director further folds the half of the paper-like medium, which is folded one time, in a further half outward in a manner such that the folded page is opened outside (see part (b) in FIG. 7), and a character string representing the number of print pages is recorded on the page which is opened outside. This is directions that the fifth page of printed matter is folded a half as shown in part (b) of FIG. 7. In addition, reference numerals 21 and 25 denote creases (folds) in FIG. 7.

Thus, when the paper-like medium 2 by which the directions input is carried out is developed and the directions input side is read by the scanner device 45, the image data 5 containing the character string 55 representing the number of print pages and two creases (folds) 51 and 55 will be acquired (see part (f) of FIG. 7). In the printing support system 100A, the creases 51 and 55 are recognized based on the image data 5 by the fold directions recognition section 112a, and the information that the crease 44 is the directions for further folding the divided page in a half in the form of a mountain fold is acquired. Then, the character string 54 is recognized by the character directions recognition section 112c, and the number of print out pages (“5”) is acquired, so that it can be acquired that the added directions information is directions information on the fifth page.

Thus, after inputting the whole print out form, you may enable it to input additionally the directions information on detailed print out form over each page.

In addition, with the above embodiment, when the paper-like medium includes a fold, the image data is obtained by the scanner device 45 in the state in which the paper-like medium is developed. Alternatively, however, the scanner device 45 may read the paper-like medium in the state in which the paper-like medium folds up. In such a case, the overlapped portion of the paper-like medium 2 is recognized, and the developed form may be assumed at the system side. Moreover, although the entry of the directions is performed with respect to only one side and the only one side is read out by the scanner device 45, but the entry of the directions may be performed on both sides of the paper-like medium. With the above-mentioned embodiment, the printing support system 100A is constructed by one host terminal 100. However, the above-mentioned processing units 110, 120, and 130 are connected in a communicable manner, and all of the processing units 110, 120, and 130 may be discrete devices or arranged in a plurality of devices in the distributed form. For example, the printing definition data generation unit 130 may be arranged at the printing device side.

Moreover, although the above-mentioned embodiment shows the example in which the printing job definition data is generated as the printing control information, the invention is not limited thereto. Moreover, the printing control information about the directions of the print form other than the print out form may be acquired.

In the example of FIG. 8, the printing director records the size of the print out form (A4 size) (see part (b) of FIG. 8) and an extended specifying recognizer 26 so as to surround a smaller range in the shape of a rectangle than the paper-like medium 2 (see part (c) of FIG. 8). This is the directions which perform printing which on the occasion of printing, the paper of somewhat larger size than the print out form size is used and the print out form size (A4 size) is in a range on the paper, which corresponds to a range which is surrounded by extended specification recognizer. In addition, after printing, a bigger portion than the print out form size is cut away and thus the print out form size is formed. In the printing support system, the extended specifying recognizer 26 is recognized from the image data on the paper-like medium 2, the position is identified, and the printing parameter about the paper size or a print range used for printing is generated and outputted to the printer.

Thus, directions about the print form which is not treated as the printing job definition data which describes the print out form is also in the scope of the invention. The printing parameters (setup to a printer) may be generated based on the directions information, and the print form relating to the directions may be realized.

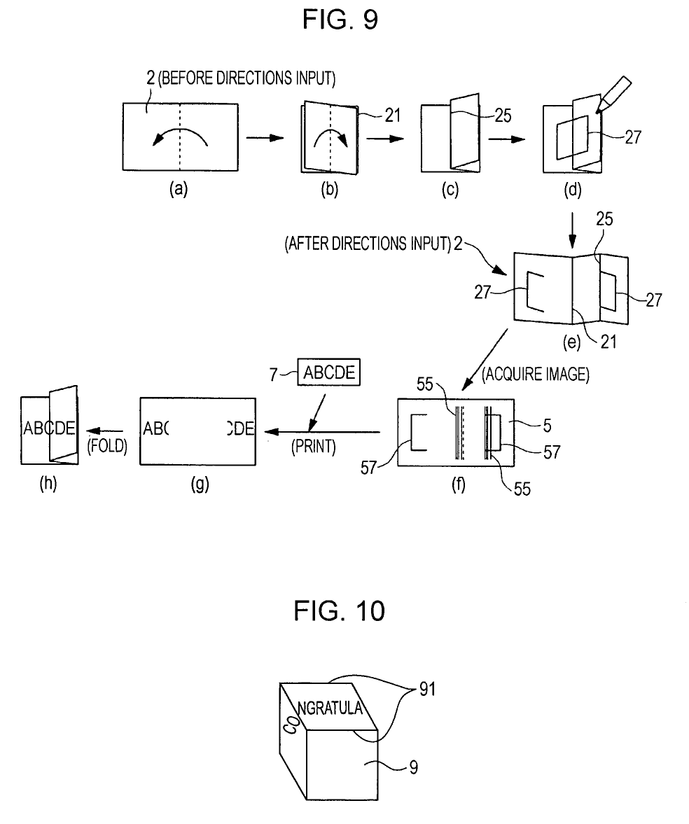

Moreover, in the example of FIG. 9, after the printing director folds one side of the paper-like medium 2 (see parts (a) to (c) of FIG. 9), and contents data 7 and an imposition domain are surrounded by an imposition position specifying recognizer 27 in the state in which the paper-like medium 2 is folded. In the printing support system, the imposition position specifying recognizer 57 is recognized from the image data 5, the coordinates on the paper-like medium 2 are acquired, the coordinates on print media are acquired based on this, and the printing control information, such as printing job definition data is generated (see part (e) of FIG. 9). When the imposition domains separates from each other in the development side, an image processing function is provided in the printing support system, the contents data 7 is divided so as to correspond to the separated imposition domains, the imposition coordinates are assigned to imposition domains, respectively, and the printing control information including each imposition coordinate is generated. In addition, the processing about the fold directions is the same as that of the above-mentioned embodiment.

Thus, the contents data 7 is suitably printed on the development side of the printing medium in the imposed state (see part (g) of FIG. 9), and the contents data divided and printed on the development side is continuously displayed in the print out form including a fold (see part (h) of FIG. 9). In such a scene, if the paper-like medium 2 is used, a big effect will be demonstrated. In addition, the imposition position specifying recognizer corresponds to the print position specifying recognizer according to the aspect of the invention.

Of course, in the case of FIG. 9, directions of the fold are performed. Alternatively, only directions of imposition may be performed, reproducing the fold without performing the direction of fold. By this way, as shown in FIG. 10, it is applicable to the wrapping paper 9, origami, etc. For example, as shown in FIG. 10, in the case of continuously printing a picture over three consecutive outer surfaces of the wrapping paper 9 in the state in which the wrapping paper 9 is wrapping an article, it is possible to simply perform the imposition specification by drawing the picture at the imposition domain 91 on the wrapping paper 9 in the state in which an article is wrapped with the wrapping paper 9.

In addition, with the above-mentioned embodiment, although directions information is recognized using image data, the acquisition method of the contents, by which the directions input is carried out, is not limited to the paper-like medium. For example, the fold directions information inputted into the paper-like medium is acquirable using Radio Frequency Identification (RF ID) sensing technology. In this case, a plurality of transponders and sensors is provided to the paper-like medium. Thus, the transponders enable transmission of the identification information of positions at which they are arranged, and the sensors are provided in a manner such that they can acquire the identification information of the positions from the transponders. Thus, when a printing director folds the paper-like medium, directions of a fold can be acquired by detecting which portion approached by the operation processing unit linked to the nearby sensor. In addition, directions information can also be recognized by an animation recognition method. In this case, a plurality of marks (two-dimension bar code etc.) is arranged on the paper-like medium, and thus the fold directions information can be acquired by detecting a motion of each mark by the operation processing unit.

The entire disclosure of Japanese Patent Application No. 2007-103669, filed Apr. 11, 2007 is expressly incorporated by reference herein.

What is claimed is:

1. A printing support system, comprising:
an acquisition unit which acquires image data by scanning a medium having a fold position as a recognizer at a position which corresponds to a fold position on a print out form;
a recognition unit which recognizes the recognizer from the image data;
an identification unit which identifies a position on the medium, the position corresponding to the fold position on the print out form on the basis of the recognized recognizer; and
a generation unit which generates printing control information which specifies the print out form on the basis of the identified position.

2. The printing support system according to claim 1,
wherein the recognizer is a crease on paper, which is formed by folding the medium and
wherein the recognition unit recognizes the crease from the image data as the recognizer which specifies the fold position.

3. The printing support system according to claim 1,
wherein a staple position specifying recognizer is provided at a position on the medium, the position corresponding to a staple position on a print form as the recognizer,
wherein the recognition unit recognizes the staple position specifying recognizer, and
wherein the identification unit identifies a position on the medium having the recognized staple position specifying recognizer, the position corresponding to the staple position on the print form.

4. The printing support system according to claim 1,
wherein a print position specifying recognizer is provided at a position or a range on the medium, the position or the range corresponding to a print position or a print range of contents on a print form, as the recognizer,
wherein the recognition unit recognizes the print position specifying recognizer, and
wherein the identification unit identifies a position on the medium having the recognized print position specifying recognizer, the position corresponding to the print position or the print range of contents on the print form.

5. The printing support system according to claim 1, wherein the recognition unit includes a character directions recognition portion which recognizes a character shown in the image data.

6. The printing support system according to claim 1, wherein the generation unit includes a printing job definition data generation portion which generates printing job definition data which specifies a print form which corresponds to the identification result made by the identification unit.

7. A printing support method, comprising:
acquiring image data by scanning a medium having a fold position as a recognizer at a position which corresponds to a fold position on a print out form;
recognizing the recognizer from the image data;
identifying a position on the medium, the position corresponding to the fold position in the print out form on the basis of the recognized recognizer; and
generating printing control information which specifies the print out form on the basis of the identified position.

8. A printing support system which includes a program causing a computer to execute a processing, comprising:
acquiring image data by scanning a medium having a fold position as a recognizer at a position which corresponds to a fold position on a print out form;
recognizing the recognizer from the image data;
identifying a position on the medium, the position corresponding to the fold position on the print out form on the basis of the recognized recognizer; and
generating printing control information which specifies the print out form on the basis of the identified position.
